(19) United States
(12) Patent Application Publication
(10) Pub. No.: US 2010/0307304 A1
(43) Pub. Date: Dec. 9, 2010

(54) Apparatus and method for the slicing of food products

(75) Inventor: Guenther Weber, Gross Nemerow (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Weber Maschinenbau GmbH Breidenbach, Breidenbach (DE)

(21) Appl. No.: 12/791,195

(22) Filed: Jun. 1, 2010

(30) Foreign Application Priority Data
Jun. 3, 2009 (DE) 10 2009 023 751.8

(51) Int. Cl. B26D 7/06

(52) U.S. Cl. 83/13; 83/403.1

(57) ABSTRACT

An apparatus for the slicing of food products has a product feeder which includes a plurality of belt conveyors arranged parallel next to one another. The belt conveyors each include an endless belt serving as a product support for a product to be sliced and they are drivable together in order simultaneously to feed a plurality of products which each lie on one of the belts to a cutting plane in which a cutting blade moves. The belt conveyors have a common drive with a drive shaft. For the setting of an individual single conveying speed for each belt conveyor, a respective setting apparatus is associated with them which is made to individually change the running diameter of the drive shaft in the region of the belt.

The present invention relates to an apparatus and to a method for the slicing of food products.

Different types of food slicing apparatus are known in the prior art. For example, so-called high-performance slicers are used to slice food products such as meat, sausage or cheese at a high cutting speed. In an endeavor further to increase the cutting performance, such apparatus can have a product feeder which is made to feed a plurality of product loaves or product bars—in the following simply: products—parallel to one another to a common cutting blade which moves in a cutting plane which extends perpendicular to the product conveying direction. It is possible in this manner to utilize a single cutting apparatus—with a correspondingly large blade—for the simultaneous cutting of a plurality of products.

Such a high-performance slicer with independent product feeders for two products to be conveyed in parallel and thus to be sliced simultaneously is described in European patent EP 0 713 753 B1. In this slicer, each product to be sliced is pushed in the direction of the blade by means of a separate driven gripping claw which engages at the rear product end. The gripping claws each have their own drive and can accordingly be driven completely independently of one another at different feed speeds so that it is possible to change the thickness of the cut product slices for the conveyed products by means of the individual product feeder drives independently of one another during the slicing.

Slicers with mutually independent product feeder drives for two products to be sliced simultaneously are moreover known from U.S. Pat. No. 3,605,837 and U.S. Pat. No. 3,927,319. Each product is in this respect clamped during the slicing between two oppositely disposed endless belt conveyors which are oriented vertically and which can both hold the product and feed it to a cutting plane at a changeable feed rate. Each pair of endless belt conveyors provided for a respective product has its own drive for the product feeder, with the drives being completely independent of one another so that the product feeder rates of the products to be sliced can be changed independently of one another.

Above all the relatively high effort which is required for the provision of a plurality of mutually independent drives including the associated control devices is problematic with these known apparatus.

It is therefore an object of the invention to simplify the simultaneous slicing of a plurality of food products conveyed in parallel, with the thickness of the cut product slices being able to be changed individually for each product.

The object is satisfied, on the one hand, by an apparatus having the features of claim 1.

The apparatus in accordance with the invention has a product feeder which includes a plurality of belt conveyors which are arranged parallel to one another, which each include an endless belt serving as a product support for a product to be sliced and which can be driven together in order simultaneously to feed a plurality of products which each lie on one of the belts to a cutting plane in which at least one cutting blade moves, in particular in a rotating and/or circulating manner. The belt conveyors have a common drive which includes a drive shaft by which the products lying on the belts can be fed to the cutting plane at a common base conveying speed. Each belt has a setting apparatus associated with it which is made to individually change the running diameter of the drive shaft in the region of the belt and thus the individual conveying speed of the belt.

It was recognized in accordance with the invention that with cutting apparatus of the generic kind, products are to be cut up in practice which usually largely coincide with respect to their outer shape and which only vary to a relatively small degree with respect to their cross-sections. In order either to produce individual product slices or portions of product slices of the same weight, the products can therefore substantially be conveyed at the same speed, with only relatively slight adaptations being required for the exact observance of the preset slice weight or portion weight These adaptations are themselves not only relatively slight for each product, but are also additionally in the same order of magnitude for all products to be sliced simultaneously. The invention utilizes this circumstance.

In accordance with the invention, the construction and manufacturing effort can thus be considerably reduced in that a set of parallel belt conveyors is provided which are driven in common, but which are individually adjustable. For this purpose, a common drive having a drive shaft is provided, with the drive shaft defining a running surface with a specific running diameter in the region of each belt. The running surface can in particular be formed by a drive roller rotationally fixedly connected to the drive shaft. The term “running diameter of the drive shaft” can thus also relate to one or more additional components rotationally fixedly connected to the drive shaft. The circulation speed of a belt and thus the individual conveying speed of the respective belt conveyor depends on the speed of the drive shaft and on the running diameter for the respective belt. If the running diameter is variable, the individual conveying speed can be individually changed while keeping constant the speed of rotation of the drive shaft for every individual belt.

The running diameter of the drive shaft is preferably variable for every belt during the slicing operation with a circulating belt. The adaptation of the individual conveying speed can thus take place “online” so-to-say without a delay or interruption of the ongoing cutting operation being necessary. Products having a cross-sectional shape changeable in the longitudinal direction can thus in particular also be sliced while maintaining a uniform slice weight or portion weight, which requires a constant adaptation of the individual conveying speed during the slicing.

In accordance with a further embodiment of the invention, for each belt, its individual conveying speed can be changed by means of the setting device whose limits are determined in that the base conveying speed can be reduced and increased by a specific maximum amount, with the base conveying speed, for example, being able to be decreased by up to 20% and increased by up to 20%. The respective then current value of the individual conveying speed can therefore vary for each of the belt conveyors by a common value which is given by the base conveying speed. The base conveying speed is therefore so-to-say only changed with a relatively small range.

The running diameter of the drive shaft is preferably changeable in a stepless manner for each belt to ensure an exact adaptation of the respective individual conveying speed to the then current circumstances or to the respective requirements.

In accordance with a further embodiment, each belt is changeable in length by elastic stretching and/or is provided with a clamping device for the adaptation to a change of the running diameter. The length change associated with a change of the running diameter can be compensated by these measures in order thus always to ensure an evenly tautened circulation of the belt. The clamping device can e.g. be a clamping roller cooperating with the empty run of the belt conveyor and acted on by spring force.

In accordance with a further embodiment, each setting apparatus includes two conical plates which are rotationally fixedly connected to the drive shaft and which are axially displaceable relative to one another. The conical plates can in particular cooperate with a V-belt whose peripheral surface is made as a running surface for the belt. The conical plates whose tapered sides face one another form a running surface pair for the symmetrical support of the V-belt side surface. The cross-sectional shape of the V-belt is expediently adapted to the conical shape. On an axial moving together of the two conical plates, a force transmission to the V-belt takes place via the corresponding oblique surfaces of the conical plates, whereby said V-belt is pressed radially outwardly and accordingly runs on a larger effective diameter. Conversely, the V-belt slips radially inwardly when the conical plates move apart axially.

An arrangement of axially adjustable conical plates is used, as is known, for belt drives which can be adjusted in a stepless manner to change the speed of the output shaft with an unchanged speed of the drive shaft. In the described embodiment of the invention, however, the speed of the output shaft is of no interest since no output takes place via a common return shaft for the belts which is provided, for example, and which is freely journalled. What is rather important here is the change of the track speed of the belt called a belt here; it can be used in an advantageous manner for the setting of the individual conveyor speed of the respective belt conveyor and indeed in particular independently of any change in the speed of rotation of the return shaft.

The axial relative movement of the conical plates can be brought about by different types of setting apparatus. For example, external drivers or mutually journalled hollow shaft sections can be provided.

The V-belt transmits the driving torque in an advantageous manner from the conical plates to the circulating belt. Generally, however, the belt used for the conveying of the products and serving as a product support could also itself be made in the manner of a V-belt and circulate without an additional interposed V-belt on the conical plates as well as e.g. on a freely rotatable return shaft.

In accordance with an embodiment, each V-belt contacts the conical plates over the full periphery. The V-belt can thereby take up a high driving torque from the conical plates. The change in the running diameter takes place while deforming the V-belt. The V-belt is therefore stretched when the conical plates move axially toward one another. The V-belt is relaxed accordingly when the conical plates move away from one another.

In accordance with an alternative embodiment, each V-belt has a length which is larger than the outer diameter of the conical plates, with the V-belt being pressed toward the conical plates by the belt and only contacting the conical plates within the active arc. The non-pressed on part of the V-belt is deflected and has no contact with the running surfaces of the conical plates. In this embodiment, no deformation of the V-belt is necessary to change the running diameter so that only relatively small axial adjustment forces are required and a drive provided for the adjustment can be dimensioned accordingly small. In addition, the V-belt in this embodiment can be removed particularly simply from the conical plates for servicing or cleaning purposes.

In accordance with an embodiment, each belt is pretensioned. This is in particular advantageous because the V-belt is in this manner pressed toward the running surfaces of the conical plates by the belt so that the V-belt is also in friction-locking engagement with the driving conical plates in the presence of a loosely deflected section.

In accordance with a further embodiment of the invention, each belt has an upper belt associated with it which is made to act on the upper side of the product. Such an additional belt can even be made without a drive and only free-running so that the upper belt unit exerts a holding-down function, whereby a particularly reliable product positioning, product holding, or product guidance is achieved during the slicing. The product to be sliced is therefore so-to-say clamped between two circulating belts disposed opposite one another and are conveyed in this manner. It is also possible that each upper belt is drivable and in this respect can be synchronized with its lower belt, that is its “partner belt” serving as a product support. The product is then conveyed, as in the initially named prior art in this respect, by the lower belt and the upper belt together.

This object is satisfied, on the other hand, by a method having the features of claim 13.

In the method in accordance with the invention for the slicing of food products, a plurality of products which each lie on one of the belts are supplied simultaneously to a cutting plane in which at least one cutting blade is moved, in particular in a rotating and/or circulating manner, by means of a product feeder which includes a plurality of belt conveyors which are arranged in parallel next to one another and which each include an endless belt serving as a product support for a product to be sliced. The belts are driven by means of a common drive and the running diameter of the drive shaft in the region of the belt is changed individually as required in order to set the thickness of product slices to be cut individually for each product

In accordance with an embodiment, the running diameter of the drive shaft is changed for each belt in dependence on the contour of the product, with the contour of the product preferably being determined using a detection device integrated into the apparatus. As soon as a product region with a reduced cross-sectional surface, for example, therefore moves to the cutting plane on the slicing of the product, the individual conveying speed of the respective belt conveyor is increased by a corresponding amount so that as a result the product slice weight remains unchanged. The cutting apparatus is aware of the topography of the product and thus of the contour extent of the product in the conveying direction, so that it is also known when which product cross-sectional surface arrives at the cutting plane so that a respective desired slice thickness can be produced by corresponding control of the setting apparatus, and indeed—if desired—with a slice thickness varying from slice to slice. The principle of the direct change of the product feeder in dependence on the product contour is known per se so that this should not be looked at in any more detail.

The invention will be described in the following by way of example with reference to the drawing.

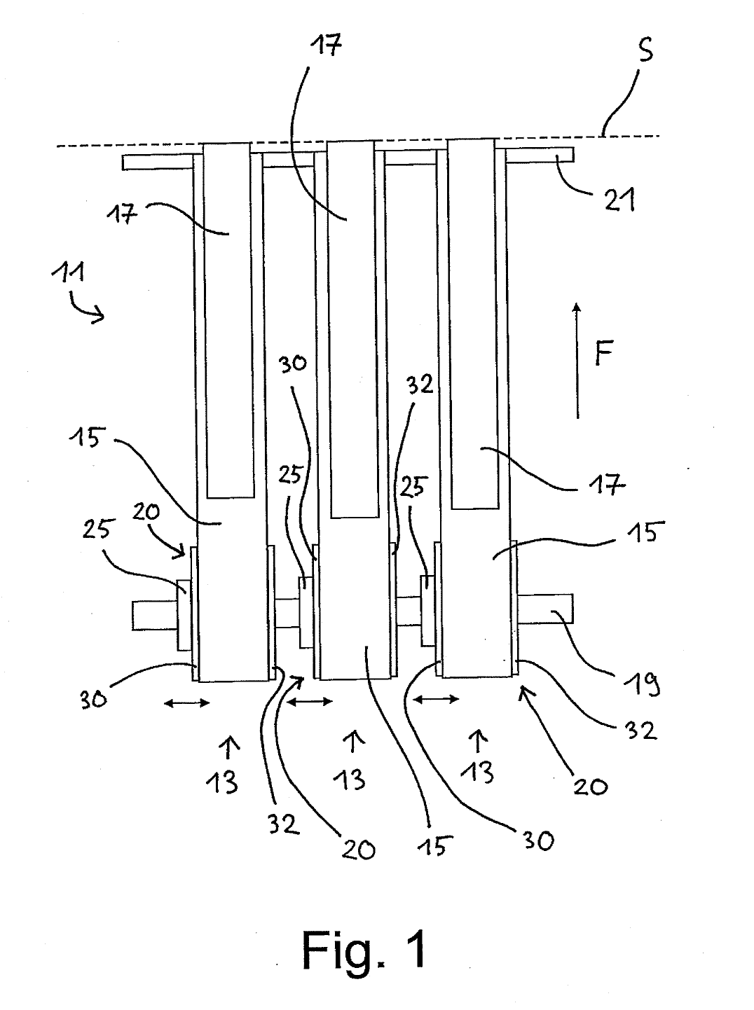

FIG. 1 schematically shows a plan view of the product feeder region of a cutting apparatus in accordance with the invention;

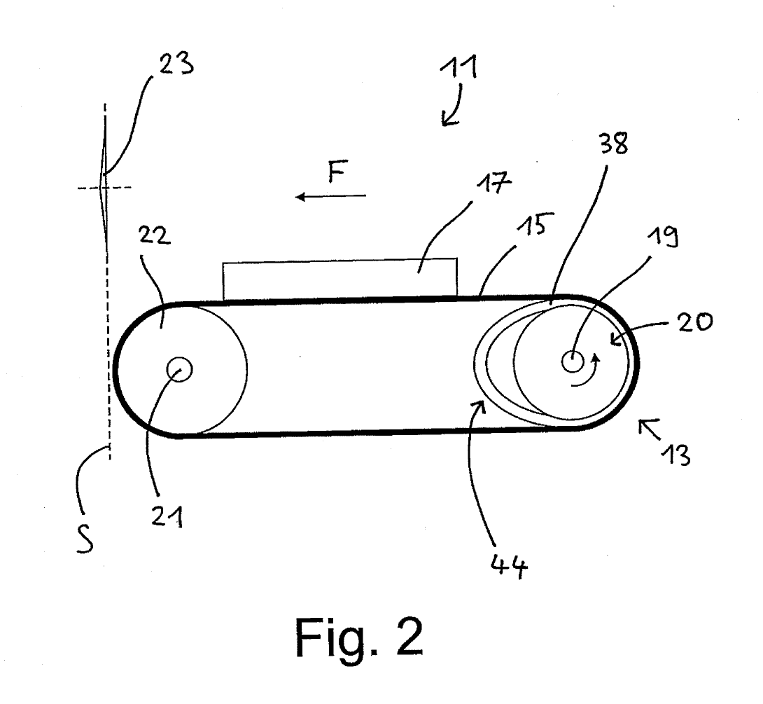

FIG. 2 schematically shows a side view of the cutting apparatus in accordance with FIG. 1;

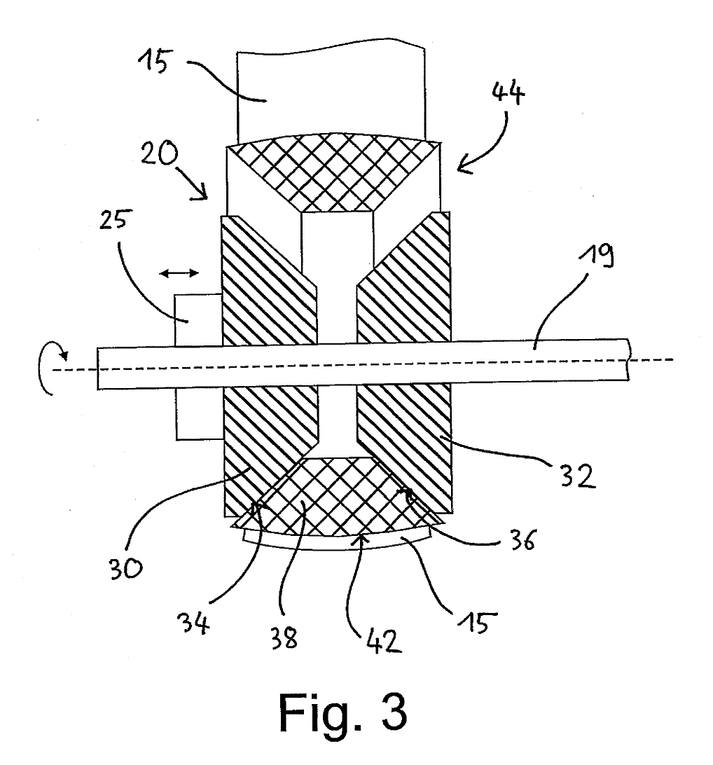

FIG. 3 shows an enlarged sectional view of a setting apparatus for a belt conveyor of the cutting apparatus in accordance with FIG. 1; and

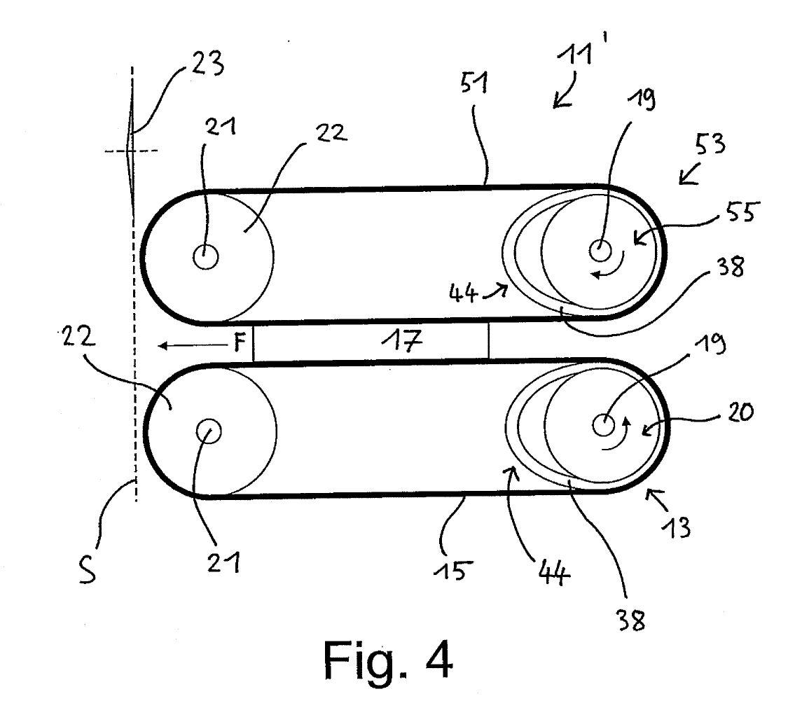

FIG. 4 schematically shows a side view of a cutting apparatus in accordance with an alternative embodiment of the invention.

The cutting apparatus in accordance with the invention includes a product feeder 11 with, in this example, three belt conveyors 13 arranged next to one another and aligned parallel to one another. Each of the belt conveyors 13 includes an endless belt 15 which serves as a support for a product 17 to be sliced. The belts 15 are driven by a common drive shaft 19 on which respective drive rollers 20 are seated. The belts 15 furthermore run freely around a return shaft 21 having return rollers 22 (FIG. 2), with the return rollers 22 being arranged close to a cutting plane S

A cutting blade 23 (FIG. 2) rotates in a planetary manner in the cutting plane S, with alternatively a cutting blade, in particular a scythe blade, also being able to be used which does not rotate in a planetary manner, but rather only rotates. The return rollers 22 can also be journalled separately instead of on the common return shaft 21.

The products 17 lying on the upper run of the belt conveyer 13 are fed simultaneously and parallel to one another along a product conveying direction F to the cutting plane S by driving the drive rollers 20 by means of the common drive shaft 19.

The drive of the drive rollers 20 does not have to take place directly by a common coaxial drive shaft 19. Depending on the embodiment, it is also possible that different transmission components are provided as an intermediate member between the drive shaft 19 and the respective drive roller 20. The drive shaft 19, however, ultimately represents a common drive for all belt conveyors 13.

The design of the drive rollers 20 will be explained in more detail with reference to FIGS. 2 and 3. Each drive roller 20 is composed of two coaxial conical plates 30, 32 which are rotationally fixedly connected to the drive shaft 19. The conical plates 30, 32 form a pair of running surfaces 34, 36 for a V-belt 38. The cross-sectional shape of the V-belt 38 is matched to the shape of the conical plates 30, 32 so that the V-belt 38 contacts the running surfaces 34, 36 areally in the region of the active arc of the drive roller 20. The respective associated belt 15 is tensioned via the V-belt 38 so that the peripheral surface 42 of the V-belt 38 forms a running surface for the belt 15. The belts 15 are made as elastically stretchable transport belts and are under a bias. The V-belt 38 is pressed toward the running surfaces 34, 36 in this manner, whereby a friction locking is established between the conical plates 30, 32 and the V-belt 38 as well as between the V-belt 38 and the belt 15.

In each of the belt conveyors 13, one of the two conical plates 30, 32 is axially displaceably journalled on the drive shaft 19 and can be adjusted relative to the other conical plate by means of a motor-driven setting apparatus 25. The V-belt 38 is displace in the radial direction by the adjustment and circulates on a changed running diameter, whereby a changed running diameter also results for the belt 15.

In a base state of the cutting apparatus, all the belts 15 circulate at a common base conveying speed in the stretched state so that all the products are “of the same speed” and the thickness of the cut product slices is the same for all belt conveyors 13. Since the circuit speed of the belts 15 and consequently the individual conveying speed of the belt conveyors 13 also depends on the running diameter of the respective belt 15 in addition to the speed of rotation of the drive shaft 19, the individual conveying speed of each belt conveyor 13 can be either increased or decreased with respect to the value of the base conveying speed by controlling the setting apparatus 25. This individual variation of the individual conveying speeds of the belts 15 takes place despite the common drive of the belts 15 by the common drive shaft 19 rotating at a constant speed. Since a separate setting apparatus 25 is associated with each belt conveyor 13, the individual conveying speeds can be varied individually.

As can in particular be seen from FIG. 2, each V-belt 38 has a length which is larger than the outer diameter of the conical plates 30, 32 so that a loop 44 out of engagement with the drive roller 20 forms outside the active arc of the drive roller 20. Due to this design, the V-belt 38 can easily be removed from the conical plates 30, 32 in the service or cleaning case. In addition, the V-belt 38 does not have to be stretched to effect an increase in the running diameter, which is of advantage with respect to the force required for the adjustment of the conical plates 30, 32.

The individual setting of the individual conveying speeds by a different position of the products 17 with respect to the cutting plane S is illustrated in FIG. 1, with it being assumed for easier understanding that the products 17 originally had the same lengths. Accordingly, the product 17 located at the left in FIG. 1 instantaneously runs ahead of the other products so that it instantaneously has the smallest residual length. Since the cutting blade 23 (FIG. 2) cuts through all supplied products 17 with a constant cutting frequency, the product slices cut from the products 17 are the thicker, the higher the individual conveying speed of the respective belt conveyer 13 is instantaneously.

Overall, an individual change in the individual conveying speed of each of the belt conveyors 13 within a range extending around the base conveying speed is made possible by the arrangement in accordance with the invention. The adjustment range is given by the respective extreme positions of the conical plates 30, 32. The variation range of the individual conveying speed is defined, for example, by an increase and a decrease in the base conveying speed by a maximum in each case of 20% This variation range is sufficient for practice since normally such products 17 are to be conveyed and sliced simultaneously on the individual belt conveyors 13 which only differ with respect to their outer contours, in particular with respect to the extent of their cross-sectional surfaces in the longitudinal direction, to a degree such that, for the achieving of weight-constant slices or portions, a variation of the slice thickness required for this purpose can be achieved by comparatively small relative individual conveying speed changes.

If a greater adaptation of the belt running speed should be necessary due to the properties of the products to be sliced than can be effected by a maximum possible adjustment stroke of the clamping rollers 30, it is possible at all times so-to-say to realize a common offset or a common base state shift for all belt conveyors 32 directly via the common drive, e.g. in the embodiment set forth here by an increase or decrease in the speed of rotation of the drive shaft 19.

FIG. 4 shows an alternative embodiment of the invention. In the product feeder 11′, each belt 15 has a belt 51 associated with it which acts on the supper side of the product 17 and thus provides a more reliable product guidance during the conveying process. The product 17 to be conveyed is clamped between the oppositely disposed belts 15, 51. The upper belt 51 is associated with an upper belt conveyor 53 which is designed analogously to the lower belt conveyor 13 and includes a drive roller 55 composed of two adjustable conical plates. So that the running speed of the two runs feeding the product 17 together is the same, the upper belt conveyor 53 is driven synchronously to the lower belt conveyor 33, with the synchronization in particular being achieved in that the adjustment of the conical plates 30, 32 of the lower drive roller 20 is always accompanied by an equal adjustment of the conical plates of the upper drive roller 55. This can be achieved either by means of a correspondingly controlled separate adjustment drive or by a suitable mechanical coupling of the respective conical plates. The two drive shafts 19 are accordingly also synchronized.

Provision can alternatively be made that the upper belt conveyor 53 does not have a drive and the upper belt 51 only circulates freely.

Since, in accordance with the invention, the individual conveying speeds are individually adjustable, the thicknesses of the cut product slices are adapted individually for each belt conveyor 13 without a separate drive having to be provided for each belt conveyor 13 for this reason. The effort and the costs for the provision of the product feeder 11, 11′ in accordance with the invention and thus of the total slicer can thus be reduced. A constant slice weight or portion weight can in particular be ensured for all simultaneously supplied products 17 despite product cross-sectional surfaces varying in the longitudinal product direction.

### REFERENCE NUMERAL LIST

11, 11′ product feeder
13 belt conveyor
15 belt
17 product
19 drive shaft
20 drive roller
21 return shaft
22 return roller
23 cutting blade
25 adjustment apparatus
30 conical plate
32 conical plate
34 running surface
36 running surface
38 V-belt
42 peripheral surface
44 loop
51 upper belt
53 upper belt conveyor
55 upper drive roller
S cutting plane
F product conveying direction

1. An apparatus for the slicing of food products, in particular a high-performance slicer, comprising
a product feeder (11, 11′) which includes a plurality of belt conveyors (13) which are arranged parallel to one another, which each include an endless belt (15) serving as a product support for a product (17) to be sliced and which can be driven together in order simultaneously to feed a plurality of products (17) which each lie on one of the belts (15) to a cutting plane (S) in which at least one cutting blade (23) moves, in particular in a rotating and/or circulating manner,
wherein the belt conveyors (13) have a common drive which includes a drive shaft (19) by which the products (17) lying on the belts (15) can be fed to the cutting plane (S) at a common base conveying speed; and
wherein each belt (15) has a setting apparatus (25) associated with it which is made to individually change the running diameter of the drive shaft (19) in the region of the belt (15) and thus the individual conveying speed of the belt (15).

2. An apparatus in accordance with claim 1, characterized in that the running diameter of the drive shaft (19) is changeable for each belt (15) during the slicing operation with a circulating belt (15).

3. An apparatus in accordance with claim 1, characterized in that, for each belt (15), its individual setting speed is changeable by means of the setting apparatus (25) in a range whose limits are determined in that the base conveying speed can be decreased and increased by a specific maximum degree, with the base conveying speed preferably being able to be decreased by up to 20% and increased by up to 20%.

4. An apparatus in accordance with claim 1, characterized in that the running diameter of the drive shaft (19) for each belt (15) can be changed in a stepless manner.

5. An apparatus in accordance with claim 1, characterized in that each belt (15) is changeable in length and/or is provided with a clamping apparatus for the adaptation to a change of the running diameter by elastic stretching.

6. An apparatus in accordance with claim 1, characterized in that each setting apparatus (25) includes two conical plates (30, 32) which are rotationally fixedly connected to the drive shaft (19) and are axially displaceable relative to one another.

7. An apparatus in accordance with claim 6, characterized in that the conical plates (30, 32) cooperate with a V-belt (38) whose peripheral surface (42) is made as a running surface for the belt (15).

8. An apparatus in accordance with claim 6, characterized in that each V-belt (38) contacts the conical plates (30, 32) over the full area.

9. An apparatus in accordance with claim 6, characterized in that each V-belt (38) has a length which is larger than the outer diameter of the conical plates (30, 32), with the V-belt (38) being pressed toward the conical plates (30, 32) by the belt (15) and only contacting the conical plates (30, 32) within the active arc.

10. An apparatus in accordance with claim 1, characterized in that each belt (15) is pretensioned.

11. An apparatus in accordance with claim 1, characterized in that each belt (15) has an upper belt (5) associated with it which is made to act on the upper side of the product (17).

12. An apparatus in accordance with claim 11, characterized in that each upper belt (51) is drivable and can be synchronized with a belt (15) serving as a product support.

13. A method for the slicing of food products, wherein
a plurality of products (17) which each lie on a respective belt (15), are simultaneously fed by means of a product feeder (11, 11′) to a cutting plane (S) in which at least one cutting blade (23) moves, in particular in a rotating and/or circulating manner;
wherein the product feeder includes a plurality of belt conveyors (13) which are arranged parallel to one another and which in each case include an endless belt (15) serving as a product support for a product (15) to be sliced;
the belts (15) are driven by means of a common drive, in particular a drive including a common drive shaft (19) for the belts (15); and
the running diameter of the drive shaft (19) for each belt (15) is changed individually as required in the region of the belt (15) to set the thickness of product slices to be cut individually for each product (17).

14. A method in accordance with claim 13, characterized in that the running diameter of the drive shaft (19) for each belt (15) is changed in dependence on the contour of the product (17), with the contour of the product (17) preferably being determined using a detection device integrated into the apparatus.
